(19) United States
(12) Patent Application Publication
(10) Pub. No.: US 2007/0084136 A1
(43) Pub. Date: Apr. 19, 2007

(54) Butt joint connector

(75) Inventors: Shayne Gerard Turner, Victoria (AU); Mark Francis Padula, Victoria (AU); George Kotsiopolous, Victoria (AU); John Petschel, Victoria (AU)

Correspondence Address: BROOKS KUSHMAN P.C., 1000 TOWN CENTER, TWENTY-SECOND FLOOR, SOUTHFIELD, MI, 48075, US

(73) Assignee: AUSTRALIAN CONSTRUCTION TECHNOLOGY PTY LTD, Victoria (AU)

(21) Appl. No.: 10/595,850

(22) PCT Filed: Nov. 16, 2004
(86) PCT No.: PCT/AU04/01581

§ 371 Date: May 16, 2006

(30) Foreign Application Priority Data
Nov. 18, 2003 (AU) 2003906327
May 18, 2004 (AU) 2004906298

(51) Int. Cl. E04F 21/165; E04G 21/14; E04C 3/00; E04B 1/00; E04F 13/00; B29C 65/00

(52) U.S. Cl. 52/127.1; 156/71; 156/304.3; 156/92; 52/578; 52/741.1

(57) ABSTRACT

A butt joint connector is described which includes a plurality of ribs (31, 50) which are interconnected by batons (32) or webs (52). The ribs (31, 50) define first and second arms (31a, 31b and 50a, 50b) which form attachment surfaces which are inclined with respect to one another so that when connected to butt joint edges of plasterboard, the region adjacent the butt joint edges is pulled towards the connector so as to form a recess which is filled by a filler material to finish the butt joint.

### FIELD OF THE INVENTION

This invention relates to a butt joint connector for forming a butt joint between two building sheets such as plasterboard, a method of forming the butt joint and a building structure using the connector.

### BACKGROUND OF THE INVENTION

Plasterboard is used to form ceilings and walls in buildings and, in particular, domestic premises. The plasterboard is provided with a pair of longitudinal edges which are each provided with a recess so that when two such boards are arranged side by side, the recess of one board and the recess of the other board enable the joint between the two boards to be finished. This usually takes place by locating a mesh tape along the recesses and over the longitudinal edges of the boards and applying a base coat to the recesses.

The plasterboard has smaller end edges. These edges are often cut so that the plasterboard is of a particular length and it is often necessary to butt join the smaller edge (the butt joint edge) of one plasterboard to the smaller edge (the butt joint edge) of another plasterboard to thereby form a butt joint.

There are several conventional techniques for forming a butt joint, all of which suffer from a number of drawbacks including the time taken to complete the joint, the finish which is obtained and the integrity of the joint to resist cracking.

### SUMMARY OF THE INVENTION

The present invention provides a butt joint connector for forming a butt joint between two building sheets, each respectively having a butt joint edge, comprising:
a first plurality of attachment members for attachment to one of the sheets;
a second plurality of attachment members for attachment to the other of the sheets so that the connector spans the edges of the respective sheets when the connector is attached to the sheets;
connecting elements for connecting the first and second plurality of attachment members together in spaced apart relationship; and
wherein the first and second plurality of attachment members define a concavity so that when the first and second sheets are connected to the attachment members, the sheets adjacent the edges are pulled towards the attachment members so as to define a recess adjacent the edges so that the recess can be finished with a filler to fill the recess and form the butt joint.

Preferably the concavity is an inverted V-shape.

In one embodiment the first and second attachment members comprise a plurality of transverse ribs, each rib having a first arm which forms a respective first attachment member and a second arm which forms a respective second attachment member, the first and second arms having surfaces which are inclined with respect to one another to form the inverted V-shape.

Preferably the first and second arms of each rib are arranged in the same plane.

Preferably the surfaces of the first arm are in a common first plane and the surfaces of the second arm are in a second common plane inclined with respect to the first plane.

In one embodiment the connecting elements comprise a plurality of longitudinal frame members for connecting the ribs.

In one embodiment a locator element is provided between the first and second arms at the apex of the inverted V-shape formed by the first and second arms for locating the edges of the sheets.

In another embodiment the connecting elements comprise a plurality of webs between adjacent ribs, each web having a first end and a second end connected to a respective one of the adjacent ribs, a hinge at the first and second ends for connecting the web to the respective rib, and an intermediate hinge between the first and second ends of each web, so that the connector is moveable between a collapsed position in which the web is folded and the adjacent ribs are side by side and an expanded position in which the ribs take up the spaced apart relationship by expansion of the webs about the hinges.

In this embodiment each of the ribs preferably comprises a base which defines the inverted V-shape, a pair of side walls extending upwardly from the base and at least one gusset interconnecting the base and the side walls.

Preferably the hinges are integral hinges. The hinges may be formed in the webs by a score line or the like.

Preferably the connector includes locking elements for locking the connector in the expanded position.

Preferably the locking elements are formed on the webs.

Preferably the webs comprise a first arm connected to one of the ribs by the hinge at the first end, and a second arm connected to an adjacent rib by a hinge at the second end, the first and second arms being connected together by the intermediate hinge, the first arm having a free end and the second arm being connected to the first arm at the intermediate hinge inwardly of the free end, the free end having a first connector element and the second arm having a second connector element so that when the connector is expanded, the first and second elements engage to lock the web in the expanded position.

Preferably the web includes a strut connected to one of the ribs at one end and to an adjacent rib by a frangible bridge at the other end to thereby space the ribs apart during moulding and in transportation and to hold the ribs in the retracted position, the frangible bridge being broken when the connector is moved to the expanded position and the first arm having a third connector for engaging the strut to facilitate holding of the web in the expanded position.

Preferably the first and second connectors comprise engagable hooks.

The invention also provides a method of forming a butt joint between two sheets of building material having respective edges, the method comprising:
securing a connector as described above to one of the sheets so the connector extends beyond the edge of that sheet and so the region of the sheet adjacent the edge is pulled towards the first attachment members of the connector;
connecting the sheet to a first framework member;
attaching the other sheet to the second attachment members of the connector so that the edges of the first and second sheet are adjacent one another and the second sheet is also pulled towards the second attachment member so that the sheets adjacent the edges form a recess; and
connecting the second sheet to a second building framework.

Preferably the method further comprises finishing the joint by applying a filler to fill the recess.

Preferably the first sheet is connected to the connector prior to connecting the first sheet to the first frame member. However in other embodiments the first sheet may be connected to the first frame member and then subsequently the connector connected to the first sheet.

Preferably the second sheet is connected to the second frame member before the second sheet is attached to the connector.

Preferably the step of fixing the first and second sheets to the connector comprises screwing the sheets to the connector member.

The invention also provides a building structure comprising:
a first sheet connected to a first frame member;
a second sheet connected to a second frame member, the first and second sheets having edges which are arranged adjacent one another;
a butt joint connector as described above connected to the first and second sheets between the first and second frame members and spanning the edges of the sheets, the first and second sheets being connected to the connector so that the first and second sheets adjacent the edges are pulled towards the connector to form a recess; and
a filler material applied to the recess to finish the butt joint between the first and second sheets.

Preferably the sheets are connected to the connector by screws.

In one embodiment the structure is part of a ceiling. However, in other embodiments, the structure may be a vertical wall.

The invention also provides a butt joint connector for forming a butt joint between two building sheets, each respectively having a butt joint edge, comprising:
a first attachment section;
a second attachment section, the first and second attachment sections defining a concavity therebetween;
a plurality of first connection locations on the first section, the locations being spaced apart in a direction transverse to a plane of the concavity;
a plurality of second connection locations on the second section and being spaced apart in the transverse direction; and
connecting means for interconnecting the respective first and second plurality of connection locations.

In one embodiment of the invention the respective connection locations are located on respective arms of separate ribs.

In a still further embodiment the sections could be planar sections and the locations defined by particular areas of the planar sections.

Most preferably the concavity is an inverted V-shaped.

### BRIEF DESCRIPTION OF THE DRAWINGS

Preferred embodiments of the invention will be described, by way of example, with reference to the accompanying drawings in which:

FIG. 1 is a plan view of a ceiling using a butt joint connector in accordance with one embodiment of the invention;

FIG. 2 is a view along the line II-II of FIG. 1;

FIG. 3 is a view along the line III-III of FIG. 1;

FIG. 4 is a plan view of a connector according to one embodiment of the invention;

FIG. 5 is a side elevation of the embodiment of FIG. 4;

FIG. 6 is a front elevation of the embodiment of FIG. 4;

FIG. 7 is a view of the connector of FIGS. 4 to 6 in position, from beneath the ceiling;

FIG. 8 is a perspective view of a further embodiment of the invention;

FIG. 9 is a view of the embodiment of FIG. 8 in a collapsed condition;

FIG. 10 is a view of the embodiment of FIG. 8 in a fully extended condition;

FIG. 11 is a side elevation generally along the line IX-IX of FIG. 8;

FIGS. 12, 13 and 14 are schematic views showing how the connector of the preferred embodiments is used to form a butt joint between two sheets;

FIG. 15 is a plan view of a butt joint connector according to a further embodiment of the invention;

FIG. 16 is a view along the line XVI-XVI of FIG. 15;

FIG. 17 is a detailed plan view of part of the connector of FIG. 15; and

FIG. 18 is a detailed plan view of the connector of FIG. 17 in an expanded and locked condition.

### DETAILED DESCRIPTION OF THE PREFERRED EMBODIMENTS

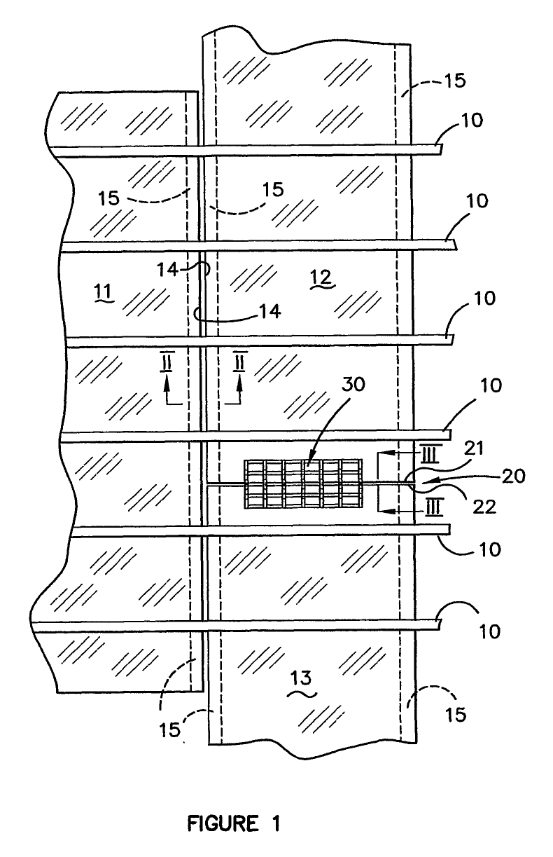

FIG. 1 is a plan view of part of a ceiling of a building which comprises frame members 10 which may be roof joists or the bottom chords of trusses or the like. Plasterboards 11, 12 and 13 are connected to the frame members 10 to form the ceiling of the building. As is conventional, the longitudinal edges 14 of the sheets 11, 12 and 13 are provided with recesses or rebates 15.

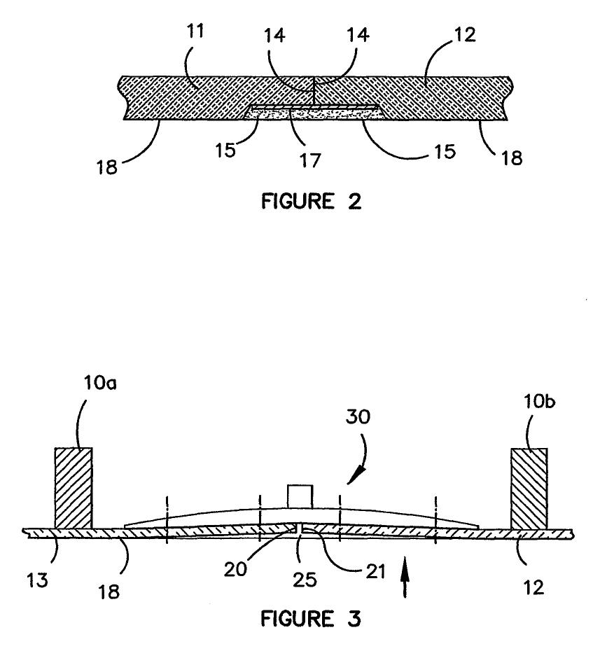

As is shown in FIG. 2, the longitudinal edges 14 are finished in the conventional way by applying a tape 17 along the recesses 15 and then filling the recesses with a filler such as a base coat. The base coat is finished by a top coat which is sanded to provide a flush finish with the internal surface 18 of the sheets 11 and 12.

It is usual when forming the ceiling or wall of a building that the plasterboard sheets 11, 12 and 13 will need to be cut to a specific length and therefore a butt joint 20 needs to be formed between the smaller edges 21 and 22 of the sheets (for example the sheets 12 and 13 shown in FIG. 1). It is also usual for the plasterboards to be staggered so that the butt joint between two plasterboards does not align directly with the butt joint between two other plasterboards. The butt joint 20 is arranged so that it is centrally located between two of the frame members 10 and a butt joint connector 30 is connected to the two sheets 12 and 13 so the connector spans the edges 21 and 22 and pulls the sheets upwardly slightly at the edges 20 and 21 to form a recess 25 which can then be filled by a filler material to finish the butt joint.

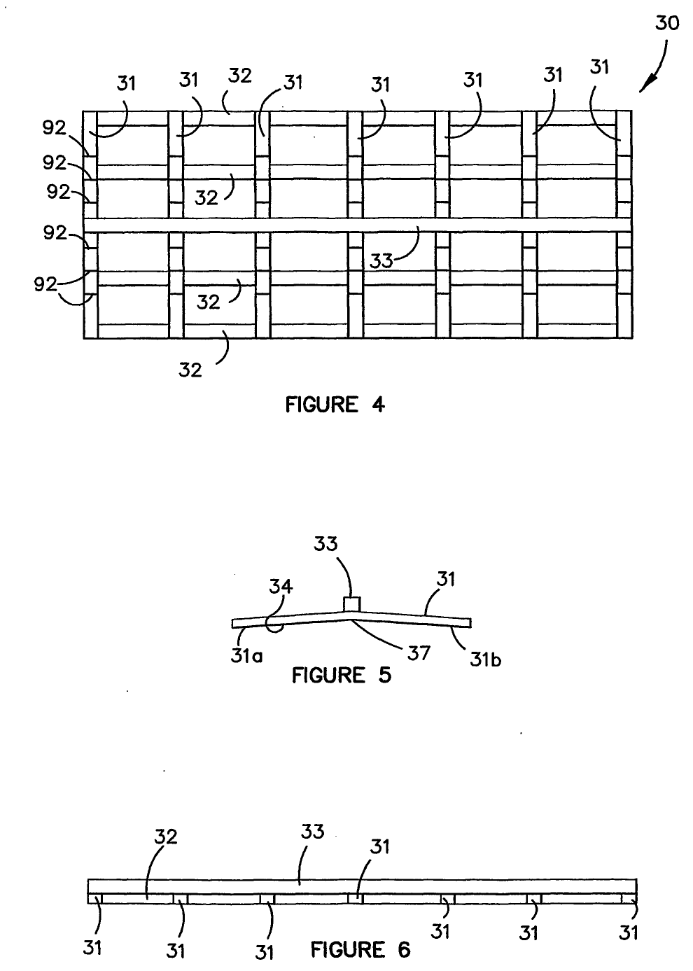

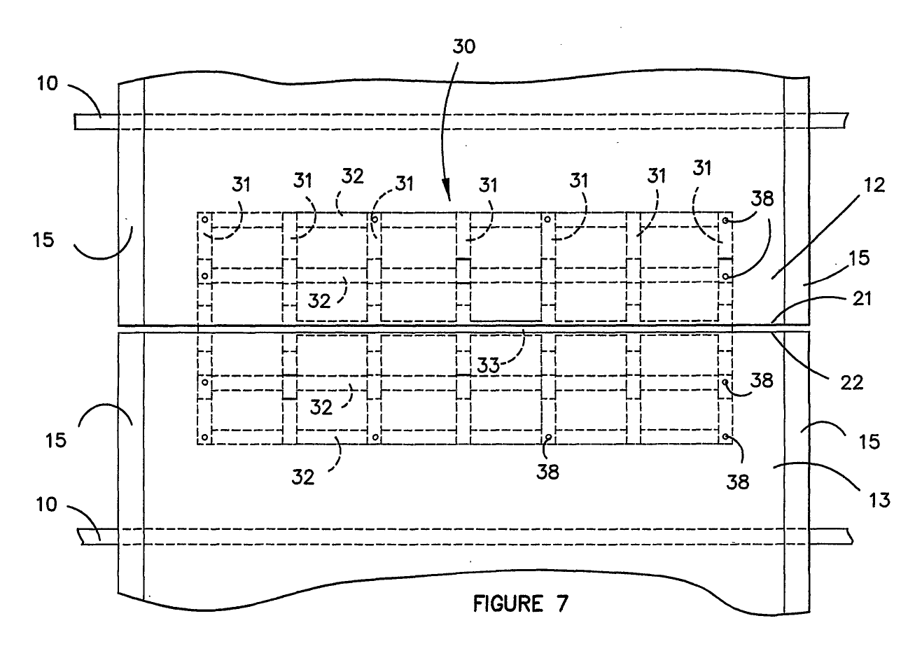

One embodiment of the connector 30 is shown in FIGS. 4 to 7. In this embodiment the connector 30 comprises a plurality of spaced apart ribs 31 which are interconnected by longitudinal batons 32. A stiffening beam 33 is applied centrally of the connector 30 to form a ridge and structurally support the ribs 31.

As is best shown in FIG. 5, each of the ribs 31 has a first arm 31a and a second arm 31b which form first and second attachment members and which are inclined with respect to one another so as to form an inverted V-shape. When in use, the concave generally referenced 37 in FIG. 3 formed by the inverted V-shape of the ribs 31 faces the plasterboards 12 and 13 previously described so that when the boards 12 and 13 are connected to the ribs 31, the plasterboard sheets are pulled into a slight inverted V-shape adjacent the edges 21 and 22 to form the recess 25 described with reference to FIG. 3.

FIG. 7 shows a view looking up towards the ceiling in which the connector 30 is secured in place to the boards 12 and 13. As can be seen in FIG. 7, the ribs 31 are connected to the respective boards 12 and 13 adjacent the edges 21 and 22 by screws 38 which are screwed through the boards 12 and 13 and up into the rib 31.

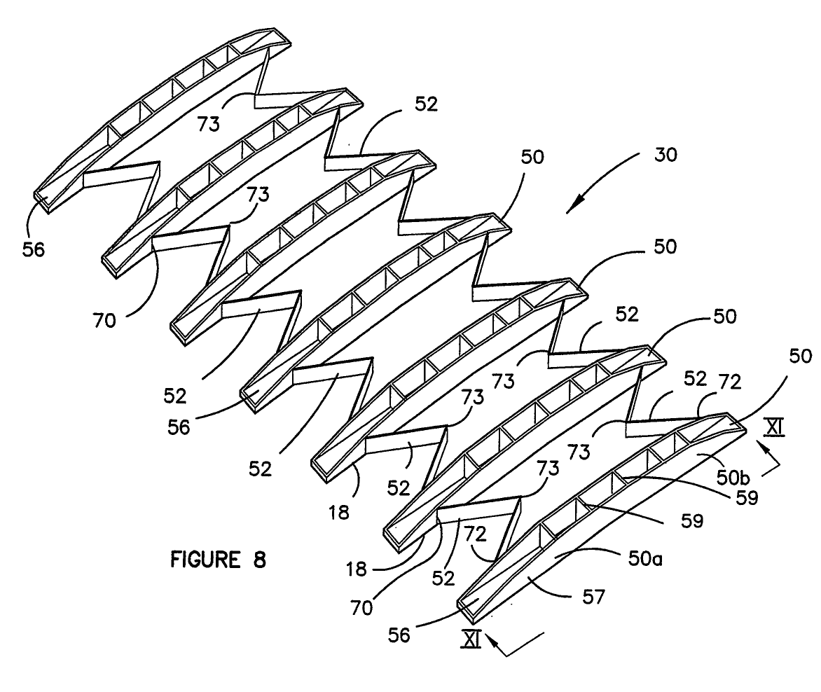

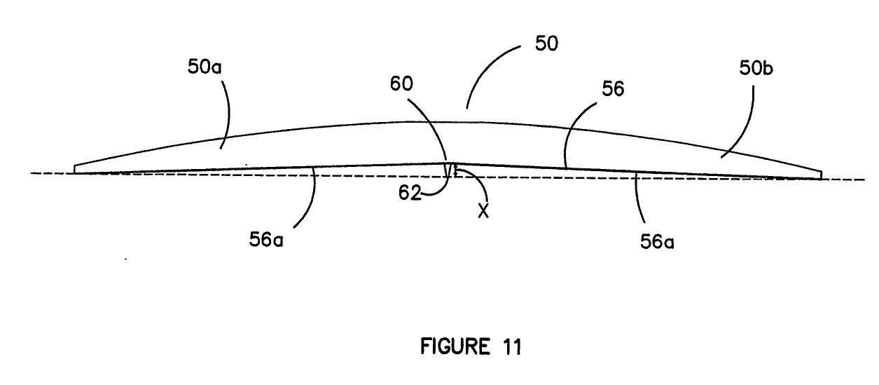

FIGS. 8 to 11 show a second embodiment of the invention. In this embodiment of the invention the connector 30 comprises ribs 50 which are interconnected by webs 52. Each of the ribs 50 has a first arm 50a and a second arm 50b which are generally formed integral and a continuation of one another. Each rib 50 is defined by a base 56, a first side wall 57, a second side wall 58 and gussets 59 which interconnect the base 56 and side walls 57 and 58. As is best shown in FIG. 11, the base 56 has lower surfaces 56a corresponding to each arm 50a and 50b which define an inverted V-shape which has an apex 60 located between the first and second arms 50a and 50b. Located at the apex 60 of each rib 50 is a locator 62 which facilitates in locating the edges 20 and 21 of the plasterboards 12 and 13 relative to the connector 30. Thus, the connector 30 is located on the board 13 by locating the locator 62 of each of the ribs 50 in engagement with the edge 20 and when the board 12 is connected to the connector 50, the edge 21 of the board 12 also abuts the locator 62 of each rib 50. Thus, the connector 30 can be located square with respect to the boards 12 and 13 for proper attachment to the boards 12 and 13.

As is best shown in FIG. 11, the depth of the incline or inverted V-shape defined by the arms 50a and 50b (in particular, the surfaces 56a at the apex 60) is about 5 to 7 mm as shown by double-headed arrow X in FIG. 11.

Each of the webs 52 has a first end 70 connected to one of the ribs 50 and a second end 72 connected to the adjacent rib 50. The connection of the ends 70 and 72 is by way of a hinge which is formed from a score line or simply from the relatively thin material from which the web 52 is formed. An intermediate hinge 73 is also provided between each end 70 and 72 so that the web 50 can take up a folded position as shown in FIG. 8.

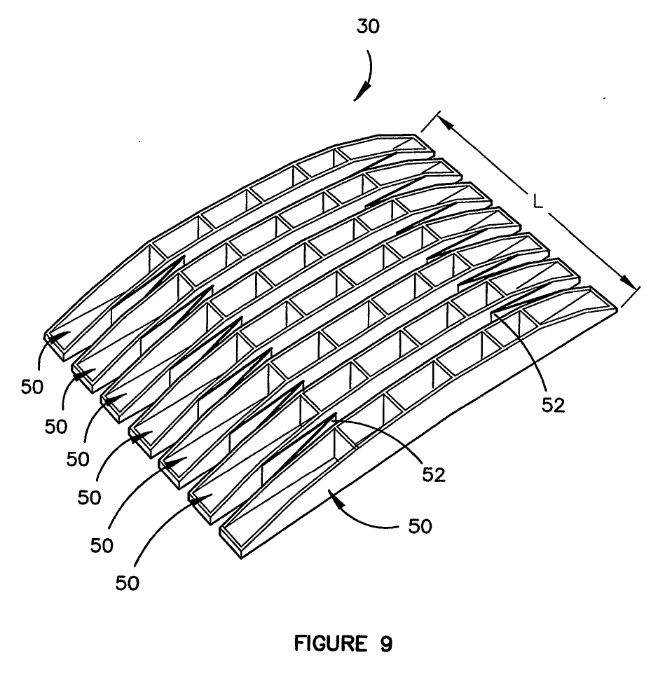

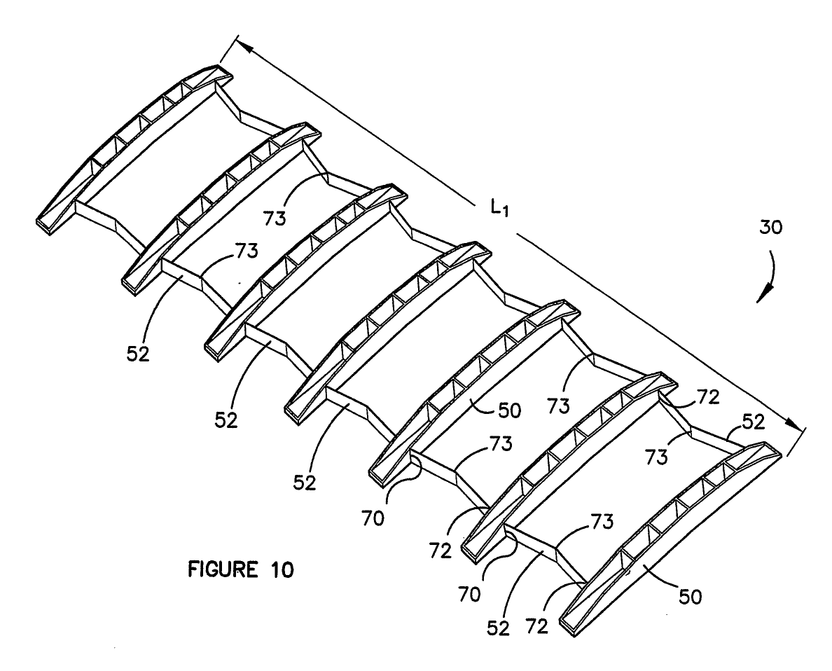

The connector 30 in the embodiment of FIG. 8 is moulded from plastic material such as recycled plastic or the like and is generally moulded in the configuration shown in FIG. 8. The hinges 70, 72 and 73 enable the ribs to be moved towards and away from one another so that the connector 30 can be collapsed into a stored position shown in FIG. 9 for storage and transportation in which the connector 30 takes up the minimum of space. When it is desired to use the connector 30, the ribs 50 are pulled apart with the webs unfolding or expanding about their hinges 70, 72 and 73 into the configuration shown in FIG. 10. Preferably in the stored or folded position shown in FIG. 9, the connector 30 has a length L of about 229 mm. In the expanded position shown in FIG. 10, the length L1 is about 900 mm. The width of the plasterboards 12 and 13 is approximately 1200 mm and therefore the connector, when installed in the manner shown in FIG. 1, extends a substantial portion of the width of the plasterboards 12 and 13. The space between the ends of the connector 30 and the frame members 10 provide room for backboards (not shown) to extend past the connectors 30.

The surfaces 56a of the arm 50a of each rib 50 are in a first common plane, and the surfaces 56a of each arm 50b of the ribs 50 are in a second common plane which is inclined with respect to the first plane so as to form the inverted V-shape described above. Similarly, the surfaces 37 of the arms 31a and 31b in the embodiment of FIGS. 4 to 6 are also in respective common planes which are inclined with respect to one another to form the inverted V-shape.

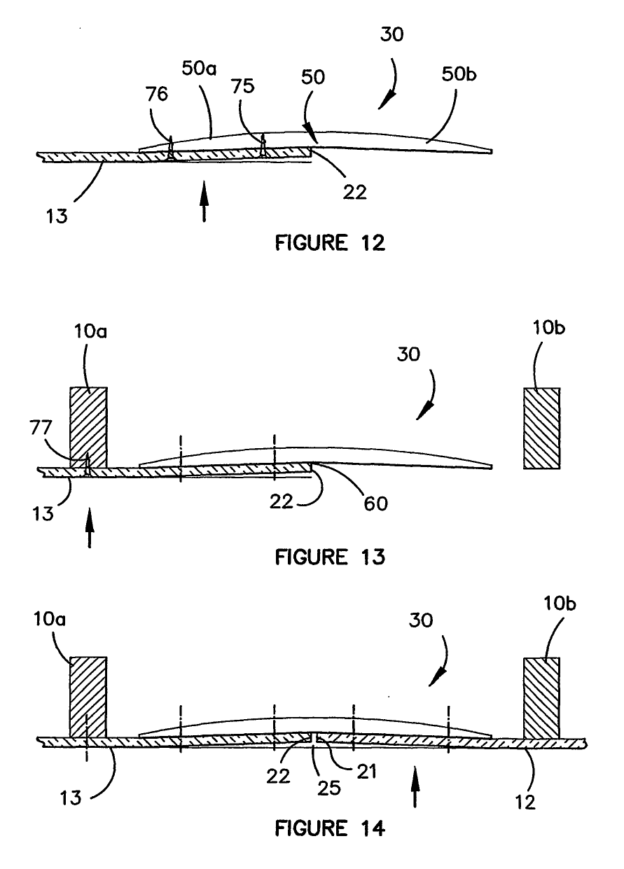

FIGS. 12 to 14 show the method of forming the butt joint according to the preferred embodiments of the invention using the connector 30 described above. It should be noted in FIGS. 12 and 14 that the connector 30 is schematically shown.

In FIG. 12, the plasterboard 13 is connected to the connector 30 by locating the connector 30 so that the locators 62 described with reference to FIG. 11 abut the edge 22 of the plasterboard 13. This ensures that the connector 30 is square and properly located with respect to the plasterboard 13. The plasterboard 13 is then screwed to each of the ribs 50 by respective first screws 75 which are screwed through the plasterboard 13 and into the ribs 50 at about 20 mm from the apex 60 and locator 62. Respective second screws 76 are then screwed at a distance of about 100 mm from the apex 60 and locator 62. Because of the V-shape of the surface 56a of the ribs 50 (or the surface 37 of the ribs 31), the plasterboard 13 adjacent the edge 22 is pulled upwardly against the surface 56a (or surface 37) of the first arm 50a of the rib 50.

As shown in FIG. 13, the plasterboard 13 with the connector 30 attached to it is then secured into the building framework such as to a first frame member 10a which may be one of the aforesaid roof joints or chords 10 of a roof truss as previously described. The plasterboard 13 is secured to the frame member 10a by screws 77.

Although, in the embodiment described, the connector 50 is connected to the plasterboard 13 before the plasterboard 13 is connected to the frame member 10a, the plasterboard 13 may be connected to the frame member 10a first and then the connector 50 secured to the plasterboard to take up the position shown in FIG. 13.

As shown in FIG. 14, the second plasterboard 12 is secured to the frame member 10b so that its smaller edge 21 abuts the locator 60 on each of the ribs 50 and so that the edges 21 and 22 of the plasterboards 12 and 13 are facing one another. It should be noted that the locator 60 will be positioned between the edges 21 and 22 and are of such a length that they do not extend down beyond the internal surface 18 of the boards 12 and 13, although in some embodiments, a slight projection beyond the surface 18 but within the confines of the recess 25 is possible.

The plasterboard 12 is then secured to each of the ribs 50 by screws 79 and 80 in the same manner as the board 13 was connected to the ribs 50.

Thus, as is shown in FIG. 14 and also as described with reference to FIG. 3, the regions of the plasterboards 12 and 13 adjacent edges 21 and 22 are pulled up against the V-shaped or inclined surfaces 56a of the arms 50a and 50b so that they form the recess 25 adjacent the edges 21 and 22. As shown in the drawings, the recess 25 spans the space between the edges 21 and 22. The recess 25 can then be filled with a filler material such as a base coat and top coat in order to finish the butt joint.

Thus, according to the preferred embodiment of the invention, the butt joint 20 can be easily and quickly formed. Because the surfaces 56a are in common planes, they form a constant and well defined recess 25 extending along the edges 20 and 21 which makes finishing easier and also produces a very good finish.

Because the connector member is formed from plastics material, it is able to flex slightly during movement of the building which enables the butt joint to move slightly to thereby prevent stresses due to movement cracking the butt joint and ruining the finish.

In the embodiment of FIGS. 11 to 14 previously described, the inclined surfaces 56a are solid and continuous surfaces. However, in other embodiments, the surfaces 56a may be perforated by holes or apertures to make attachment of the plasterboard to the surfaces 56a by screws more easy. This may also decrease weight of the connector 30 without sacrificing any structural integrity.

In still further embodiments the connector could be defined by two sections which define the inverted V-shape. The V-shape having a plane which defines the V-shape, as is shown in FIGS. 5 and 11. The connector 30 may have connection locations along the connector transverse to the plane of FIGS. 5 and 11. In one embodiment, these locations are defined by each of the ribs 31 or the ribs 50a or 50b which themselves are spaced apart. However, in other embodiments the locations may be located on a continuous member which forms the sections and the locations themselves spaced apart, so that when the boards 12 and 13 are pulled up against the sections, they form the recess as previously described.

In other embodiments the connector can also be used as a ceiling prop for wall channels by turning upside down so that furring channels can be screwed to the apex of the connector, and also by cutting off one of the sections, for example 50a, the connector can be used as a ceiling prop for corner wall channels.

The connector according to the preferred embodiment may also include depth gauge markings 92 on each of the ribs 31 so a plasterer can choose the desired depth for the finish. The markings 92 enable the plasterer to mark the edges of the boards 12 and 13 to thereby provide the required depth marking on the boards so the plasterer can then fill to those markings to provide the desired depth of finish.

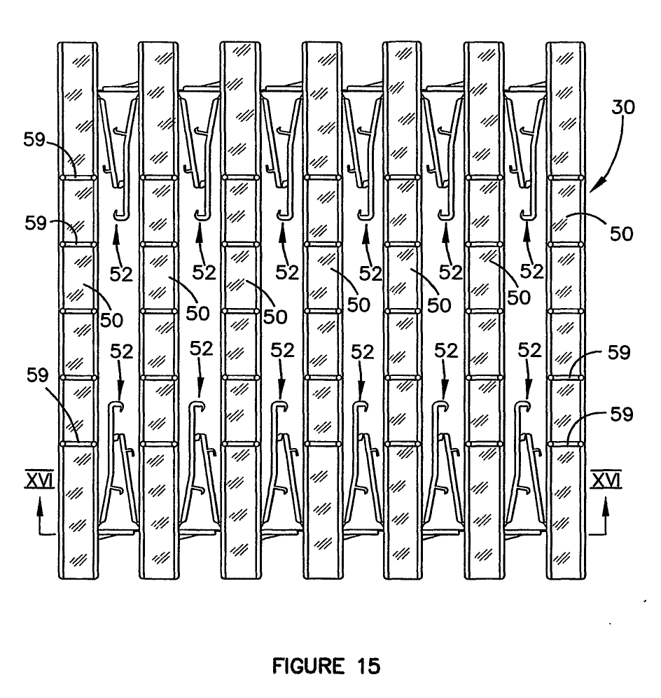

FIGS. 15 to 18 show a further embodiment of the invention in which like reference numerals indicate like parts to those previously described.

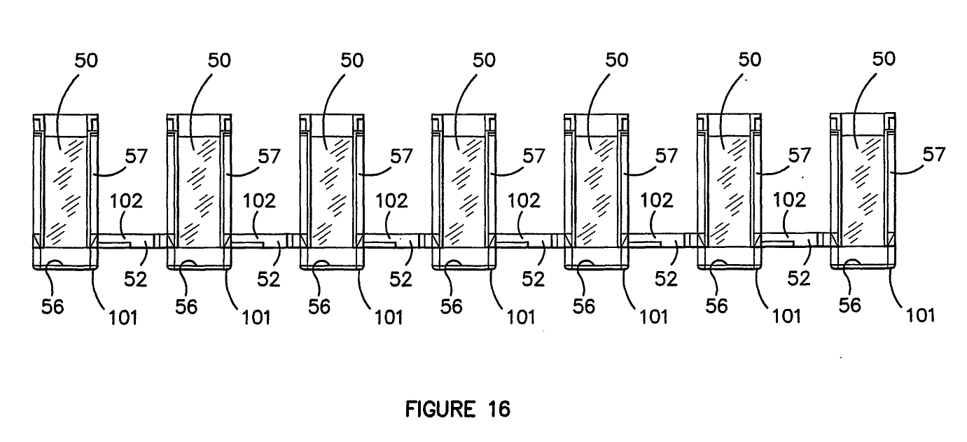

In this embodiment, as is best shown in FIGS. 15 and 16, the webs 52 are much shorter in height than the maximum height of the side walls 57 of the ribs 50. FIG. 15 shows the connector in the moulded configuration and connectors can be stacked by inverting one connector relative to the other and staggering the connectors so that the rib 50 of one connector sits between adjacent ribs 50 of another connector. Thus, the connectors take up minimal space in storage and shipping.

The bases 56 of the ribs 50 may also be provided with a surrounding bead 101 which spaces the base 56 slightly from the plasterboard. Thus, when a screw is screwed through the base 56 and plastic material of the base is drawn outwardly, the bead 101 provides space between the base 56 and the plasterboard so that the base 56 can still sit flush on the plasterboard via the bead 101.

The main difference between the embodiment of FIGS. 15 to 18 and the previous embodiment is that the webs 50 are designed to lock in position when in the expanded position so as to hold the connector in the expanded position ready for use.

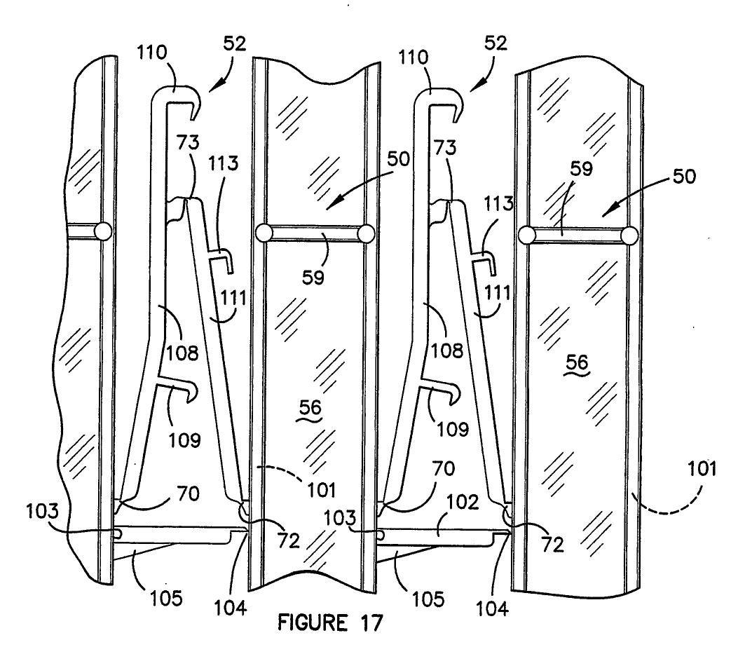

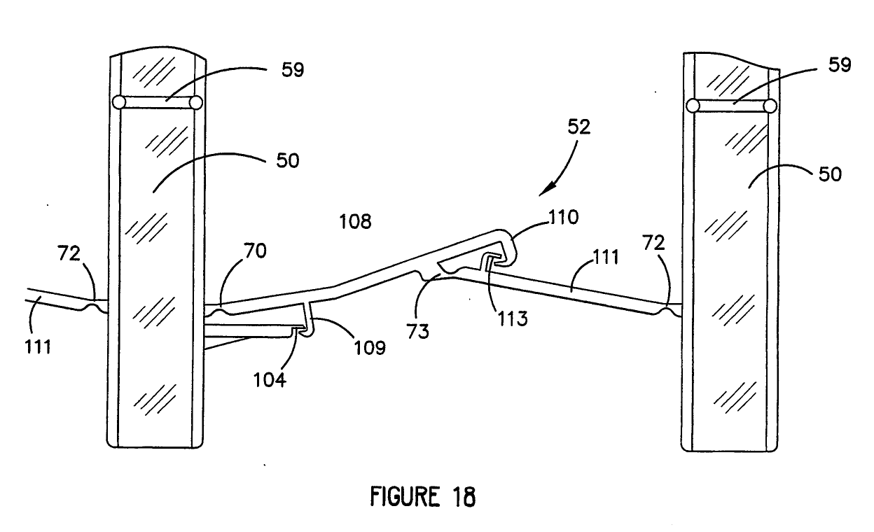

As is best shown in FIG. 17, each web 52 has a strut 102 which is connected to one of the ribs 50 at end 103 and to an adjacent rib 50 by a frangible bridge 104. The strut 102 may have a gusset 105 to strengthen the strut 102. When the webs 50 are expanded into the position shown in FIG. 18, the bridge 104 snaps to release the strut 102 from the web 50 to which the bridge 104 is connected. Thus, the purpose of the strut 102 is simply to hold the webs in the retracted position after moulding to facilitate stacking and transportation of the connectors 30 in the manner previously described.

Web 52 has a first arm 108 which is connected to the adjacent web 50 by the integral or living hinge 70 previously described. The arm 108 has a first hook 109 and an end hook 110. The web 52 has a second arm 111 which is connected to the adjacent web 50 via living hinge or integral hinge 72.

As is apparent from FIG. 17, the arm 111 is shorter than the arm 108 and is connected to the arm 108 by intermediate hinge 73. The arm 11l has a third hook 113 between the hinge 73 and the hinge 72.

When the connector is pulled to the expanded position as shown in FIG. 18 and the bridge 104 breaks, the arms 108 and 111 pivot about their respective hinges 70, 72 and 73 into a more planar configuration as shown in FIG. 18. As the arms 108 and 111 move into the planar configuration shown in FIG. 18, the hook 110 snaps over the hook 113 so that the hooks 110 and 113 engage, as shown in FIG. 18. The hook 109 snaps over the bridge 104 so that the web 52 is retained in the expanded position shown in FIG. 18 by the engagement of the hooks 110 and 113 and the hook 109 with the bridge 104. Thus, the two adjacent ribs 50 are locked in the expanded position 30 and therefore, the butt connector is much easier to install in the manner previously described.

It will be noted from FIG. 18 that the engagement between the hooks 110 and 113 and 109 and 104 is reasonably loose, thereby enabling some slight movement of the web 52 to facilitate settling when the connector is secured in place in the manner previously described.

In the claims which follow and in the preceding description of the invention, except where the context requires otherwise due to express language or necessary implication, the word “comprise”, or variations such as “comprises” or “comprising”, is used in an inclusive sense, ie. to specify the presence of the stated features but not to preclude the presence or addition of further features in various embodiments of the invention.

1. A butt joint connector for forming a butt joint between two building sheets, each respectively having a butt joint edge, comprising:
a first plurality of attachment members for attachment to one of the sheets;
a second plurality of attachment members for attachment to the other of the sheets so that the first and second attachment members extend transverse to the edges of the sheets and provide connection surface to engage the sheets when the connector is attached to the sheets;
connecting elements for connecting the first and second plurality of attachment members together in spaced apart relationship; and
wherein the first and second plurality of attachment members define a concavity so that when the first and second sheets are connected to the attachment members, the sheets adjacent the edges are pulled towards the attachment members so as to define a recess adjacent the edges so that the recess can be finished with a filler to fill the recess and form the butt joint.

2. The connector of claim 1 wherein the concavity is an inverted V-shape.

3. The connector of claim 1 wherein the first and second attachment members comprise a plurality of transverse ribs, each rib having a first arm which forms a respective first attachment member and a second arm which forms a respective second attachment member, the first and second arms being inclined with respect to one another to form the inverted V-shape.

4. The connector of claim 3 wherein the first and second arms of each rib are arranged in the same plane.

5. The connector of claim 3 wherein the surfaces of the first arm are in a common first plane and the surfaces of the second arm are in a second common plane inclined with respect to the first plane.

6. The connector of claim 1 wherein the connecting elements comprise a plurality of longitudinal frame members for connecting the ribs.

7. The connector of claim 1 wherein a locator element is provided between the first and second arms at the apex of the inverted V-shape formed by the first and second arms for locating the edges of the sheets.

8. The connector of claim 1 wherein the connecting elements comprise a plurality of webs between adjacent ribs; each web having a first end and a second end connected to the respective one of the adjacent ribs, a hinge at the first and second ends for connecting the web to the respective rib, and an intermediate hinge between the first and second ends of each web, so that the connector is moveable between a collapsed position in which the web is folded and the adjacent ribs are side by side and an expanded position in which the ribs take up the spaced apart relationship by expansion of the webs about the hinges.

9. The connector of claim 8 wherein the ribs comprise a base which defines the inverted V-shape, a pair of side walls extending upwardly from the base and at least one gusset interconnecting the base and the said walls.

10. The connector of claim 8 wherein the hinges are integral hinges.

11. The connector of claim 8 wherein the connector includes locking elements for locking the connector in the expanded position.

12. The connector of claim 11 wherein the locking elements are formed on the webs.

13. The connector of claim 12 wherein the webs comprise a first arm connected to one of the ribs by the hinge at the first end, and a second arm connected to an adjacent rib by a hinge at the second end, the first and second arms being connected together by the intermediate hinge, the first arm having a free end and the second arm being connected to the first arm at the intermediate hinge inwardly of the free end, the free end having a first connector element and the second arm having a second connector element so that when the connector is expanded, the first and second elements engage to lock the web in the expanded position.

14. The connector according to claim 13 wherein the web includes a strut connected to one of the ribs at one end and to an adjacent rib by a frangible bridge at the other end to thereby space the ribs apart during moulding and in transportation and to hold the ribs in the retracted position, the frangible bridge being broken when the connector is moved to the expanded position and the first arm having a third connector for engaging the strut to facilitate holding of the web in the expanded position.

15. The connector according to claim 13 wherein the first and second connectors comprise engagable hooks.

16. A method of forming a butt joint between two sheets of building material having respective edges, the method comprising:
securing a connector, as defined in claim 1, to one of the sheets so the connector extends beyond the edge of that sheet and so the region of the sheet adjacent the edge is pulled towards the first attachment members of the connector;
connecting the sheet to a first framework member;
attaching the other sheet to the second attachment members of the connector so that the edges of the first and second sheet are adjacent one another and the second sheet is also pulled towards the second attachment member so that the sheets adjacent the edges form a recess; and
connecting the second sheet to a second building framework.

17. The method of claim 16 wherein the method further comprises finishing the joint by applying a filler to fill the recess.

18. The method of claim 16 wherein the first sheet is connected to the connector prior to connecting the first sheet to the first frame member.

19. The method of claim 16 wherein the second sheet is connected to the second frame member before the second sheet is attached to the connector.

20. The method of claim 16 wherein the step of fixing the first and second sheets to the connector comprises screwing the sheets to the connector member.

21. A building structure comprising:
a first sheet connected to a first frame member;
a second sheet connected to a second frame member, the first and second sheets having edges which are arranged adjacent one another;
a butt joint connector as defined in claim 1 connected to the first and second sheets between the first and second frame members and spanning the edges of the sheets, the first and second sheets being connected to the connector so that the first and second sheets adjacent the edges are pulled towards the connector to form a recess; and
a filler material applied to the recess to finish the butt joint between the first and second sheets.

22. The building structure of claim 21 wherein the sheets are connected to the connector by screws.

23. The building structure of claim 21 wherein the structure is part of a ceiling or wall.

24. A butt joint connector for forming a butt joint between two building sheets, each respectively having a butt joint edge, comprising:
a first plurality of attachment members for attachment to one of the sheets;
a second plurality of attachment members for attachment to the other of the sheets so that the connector spans the edges of the respective sheets when the connector is attached to the sheets;
connecting elements for connecting first attachment members together and for connecting second attachment members together, so that the first and second attachment members can move, from a collapsed position in which the first attachment members are in side-by-side relationship and the second attachment members are in side-by-side relationship, to an expanded position in which the first attachment members are spaced apart from one another and the second attachment members are spaced apart form one another; and
wherein the first and second plurality of attachment members define a concavity so that when the first and second sheets are connected to the attachment members, the sheets adjacent the edges are pulled towards the attachment members so as to define a recess adjacent the edges so that the recess can be finished with filler to fill the recess and form the butt joint.
